(19) United States
(12) Patent Application Publication
(10) Pub. No.: US 2023/0069714 A1
(43) Pub. Date: Mar. 2, 2023

(54) IMAGE FORMING APPARATUS

(71) Applicant: FUJIFILM Business Innovation Corp., Tokyo (JP)

(72) Inventor: Ko UMENAI, Kanagawa (JP)

(73) Assignee: FUJIFILM Business Innovation Corp., Tokyo (JP)

(21) Appl. No.: 17/558,497

(22) Filed: Dec. 21, 2021

(30) Foreign Application Priority Data
Aug. 25, 2021 (JP) 2021-137628

(51) Int. Cl. G03G 15/00

(52) U.S. Cl. CPC G03G 15/6529; G03G 2215/00687

(57) ABSTRACT

An image forming apparatus includes: an annular formation target body to be transported; a change roller that is in contact with an inner peripheral surface of the formation target body so as to be rotatable around a rotation axis and that is capable of changing an angle of the rotation axis with respect to a width direction of the formation target body; multiple first image forming bodies that are arranged at a first distance from each other along the formation target body on an upstream side of the change roller in a transport direction of the formation target body, and that form images on the formation target body; and multiple second image forming bodies that are arranged at a second distance smaller than the first distance from each other along the formation target body on a downstream side of the change roller in the transport direction of the formation target body, and that form images on the formation target body.

### CROSS-REFERENCE TO RELATED APPLICATIONS

This application is based on and claims priority under 35 USC 119 from Japanese Patent Application No. 2021-137628 filed Aug. 25, 2021.

### BACKGROUND

### (i) Technical Field

The present disclosure relates to an image forming apparatus.

### (ii) Related Art

A writing device of Japanese Unexamined Patent Application Publication No. 5-084972 includes a writing unit in which a number of writing elements are arranged in a straight-line shape in the same width as an output width, the number being a number of output dots or more; a first reference position setting unit that sets the same number of first reference lines as the number of output dots perpendicularly to an arrangement direction of the writing elements; and a driving unit that selectively drives a writing element closest to each of the multiple first reference lines among the writing elements.

### SUMMARY

Aspects of non-limiting embodiments of the present disclosure relate to suppressing an increase in misregistration amount between images formed on a formation target body by multiple second image forming bodies located on a downstream side of a change roller in a transport direction of the formation target body, as compared with a case where a second distance that is a distance between the multiple second image forming bodies located on the downstream side of the change roller in the transport direction is larger than or equal to a first distance that is a distance between multiple first image forming bodies located on an upstream side of the change roller in the transport direction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an annular formation target body to be transported; a change roller that is in contact with an inner peripheral surface of the formation target body so as to be rotatable around a rotation axis and that is capable of changing an angle of the rotation axis with respect to a width direction of the formation target body; multiple first image forming bodies that are arranged at a first distance from each other along the formation target body on an upstream side of the change roller in a transport direction of the formation target body, and that form images on the formation target body; and multiple second image forming bodies that are arranged at a second distance smaller than the first distance from each other along the formation target body on a downstream side of the change roller in the transport direction of the formation target body, and that form images on the formation target body.

### BRIEF DESCRIPTION OF THE DRAWINGS

An exemplary embodiment of the present disclosure will be described in detail based on the following figures, wherein:

FIG. 1 is a general configuration diagram illustrating an image forming apparatus according to a present exemplary embodiment;

FIG. 2 is a schematic side view illustrating a transfer belt, a first photoreceptor drum, a second photoreceptor drum, a first transfer roller, and a rotational member according to the exemplary embodiment; and

FIG. 3 is a schematic cross-sectional view of a steering roller, a retract roller, and a transfer belt according to the exemplary embodiment.

### DETAILED DESCRIPTION

Hereinafter, an exemplary embodiment according to the disclosure will be described in detail with reference to the drawings. Hereinafter, an upstream side in a transport direction of recording paper P as an example of a recording medium may be simply referred to as an “upstream side”, and a downstream side in the transport direction may be simply referred to as a “downstream side”. Similarly, an upstream side in a circling direction of a transfer belt (belt) (formation target body) 52 may be simply referred to as an “upstream side”, and a downstream side in the circling direction (transport direction) may be simply referred to as a “downstream side”. In the following description, a reference position of the “upstream side” and the “downstream side” of the transfer belt is a second transfer position T2 (nip region Np) described later. That is, a direction from the second transfer position T2 toward a pressing roller 49 after passing through a driving roller 44 is the “downstream side” of the transfer belt, and a direction from the second transfer position T2 toward a second photoreceptor unit 30K after passing through a retract roller 47 is the “upstream side” of the transfer belt.

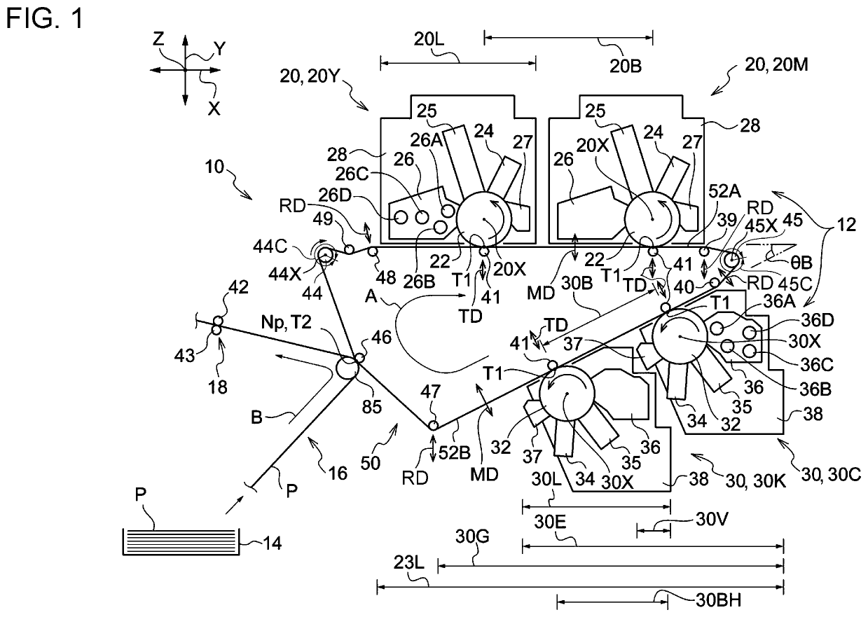

As illustrated in FIG. 1, an image forming apparatus 10 according to the present exemplary embodiment is of an electrophotographic system that forms a toner image (an example of an image) on recording paper P. The image forming apparatus 10 includes an image forming section 12, a storage section 14, a transport section 16, and a fixing device 18 in an apparatus body (not illustrated).

Hereinafter, each component of the image forming apparatus 10 will be described.

In the following description, a width direction (horizontal direction) of the apparatus body is defined as an X direction, an up-down direction (vertical direction) of the apparatus body is defined as a Y direction, and a front-rear direction (a direction orthogonal to a paper surface) orthogonal to the X direction and the Y direction is defined as a Z direction. In FIG. 1, the near side of the paper surface is a front side, and the far side of the paper surface is a rear side.

### Image Forming Section

The image forming section 12 has a function of forming a toner image on recording paper P. The image forming section 12 includes a first photoreceptor unit 20, a second photoreceptor unit 30, and a transfer device 50.

### Photoreceptor Units

As illustrated in FIG. 1, two first photoreceptor units 20 and two second photoreceptor units 30 are provided. Each first photoreceptor unit 20 and each second photoreceptor unit 30 are attachable to and detachable from the apparatus body. The image forming apparatus 10 includes first photoreceptor units 20Y and 20M for yellow (Y) and magenta (M) and second photoreceptor units 30C and 30K for cyan (C) and black (K).

In the following description, in a case where it is necessary to distinguish each color of yellow (Y), magenta (M), cyan (C), or black (K), an alphabet of Y, M, C, or K is added after a reference numeral of each member. In a case where it is not necessary to distinguish each color, an alphabet of Y, M, C, or K may be omitted.

A transfer belt 52 made of an elastic material of the transfer device 50 described later includes two straight portions that are straight-line shaped when viewed in the Z direction. The two straight portions are an upper portion 52A and a lower portion 52B. When viewed in the Z direction, the upper portion 52A extends in the X direction, and the lower portion 52B is inclined with respect to the X direction. That is, when viewed in the Z direction, an angle θB (see FIG. 1) defined by the lower portion 52B and the X direction is an acute angle, and the angle θB is larger than an angle RA (not illustrated) defined by the upper portion 52A and the X direction. Note that the angle θA is 0° or an acute angle slightly larger than 0°. When viewed in the Z direction, the upper portion 52A and the lower portion 52B are mutually arranged in the Y direction. The “straight portion” in the present specification and claims is not limited to a completely straight-line-shaped portion. For example, in the upper portion 52A located between a retract roller (first roller) 39 and a retract roller 48 described later, portions pressed by two first photoreceptor drums 22 and first transfer rollers 41 are slightly recessed; however, the upper portion 52A corresponds to the “straight portion (first straight portion)”. Similarly, in the lower portion 52B located between a retract roller (second roller) 40 and the retract roller 47, portions pressed by two second photoreceptor drums 32 and first transfer rollers 41 are slightly recessed; however, the lower portion 52B corresponds to the “straight portion (second straight portion)”. A width direction of the transfer belt 52 extends in the Z direction.

The two first photoreceptor units 20 face an outer peripheral surface (upper surface) of the upper portion 52A and are arranged in the X direction along the upper portion 52A. Each first photoreceptor unit 20 includes the first photoreceptor drum 22 that rotates in one direction (for example, the counterclockwise direction in FIG. 1). Each first photoreceptor drum 22 is rotatable around a rotation axis 20X extending in the Z direction. Each first photoreceptor unit 20 includes a first charging portion 24, a first exposure portion 25, a first developing portion 26, and a first removing portion 27 in this order from the upstream side in the rotation direction of the first photoreceptor drum 22. Each first photoreceptor unit 20 further includes a pair of support plates 28 separated from each other in the Z direction. One of the support plates 28 is not illustrated in FIG. 1. The first charging portion 24, the first exposure portion 25, the first developing portion 26, and the first removing portion 27 are members extending in the Z direction. Both end portions of the first charging portion 24, the first exposure portion 25, the first developing portion 26, and the first removing portion 27 in the Z direction are supported by the pair of support plates 28. Further, relative movement of the pair of support plates 28 is restricted. As illustrated in FIG. 1, the dimension of each first photoreceptor unit 20 in the X direction is a horizontal dimension 20L.

The two second photoreceptor units 30 face an outer peripheral surface (lower surface) of the lower portion 52B and are arranged along the lower portion 52B. Each second photoreceptor unit 30 includes the second photoreceptor drum 32 that rotates in one direction (for example, the counterclockwise direction in FIG. 1). Each second photoreceptor drum 32 is rotatable around a rotation axis 30X extending in the Z direction. Each second photoreceptor unit 30 includes a second charging portion 34, a second exposure portion 35, a second developing portion 36, and a second removing portion 37 in this order from the upstream side in the rotation direction of the second photoreceptor drum 32. Each second photoreceptor unit 30 further includes a pair of second support plates 38 separated from each other in the Z direction. One of the second support plates 38 is not illustrated in FIG. 1. The second charging portion 34, the second exposure portion 35, the second developing portion 36, and the second removing portion 37 are members extending in the Z direction. Both end portions of the second charging portion 34, the second exposure portion 35, the second developing portion 36, and the second removing portion 37 in the Z direction are supported by the pair of second support plates 38. Further, relative movement of the pair of second support plates 38 is restricted. As illustrated in FIG. 1, the dimension of each second photoreceptor unit 30 in the X direction is a horizontal dimension 30L.

In the present specification and claims, a term “image forming body” refers to a body that causes toner or ink to adhere to a formation target body (for example, the transfer belt 52). That is, the first photoreceptor drum 22 of the first photoreceptor unit 20 corresponds to a “first image forming body”, and the second photoreceptor drum 32 of the second photoreceptor unit 30 corresponds to a “second image forming body”. That is, the first charging portion 24, the first exposure portion 25, the first developing portion 26, and the first removing portion 27 do not correspond to the “first image forming body”. Similarly, the second charging portion 34, the second exposure portion 35, the second developing portion 36, and the second removing portion 37 do not correspond to the “second image forming body”. As will be described later, in a case where the image forming apparatus 10 is of an inkjet system, the inkjet head corresponds to an “image forming body (first image forming body, second image forming body)”.

A first distance 20B is a distance between two portions on which images are formed by the two first photoreceptor drums 22 or two inkjet heads on the outer peripheral surface of the upper portion 52A when viewed in the Z direction. When the first photoreceptor drums 22 correspond to the “first image forming bodies”, two line segments connecting the first photoreceptor drums 22 and the first transfer rollers 41 respectively corresponding to the first photoreceptor drums 22 intersect with the outer peripheral surface of the upper portion 52A at two intersection portions of the outer peripheral surface. When the first photoreceptor drums 22 correspond to the “first image forming bodies”, the first distance 20B is a distance between the two intersection portions when viewed in the Z direction. When the image forming apparatus 10 is of an inkjet system, the first distance 20B is a distance between center portions of inkjet heads (first image forming bodies) corresponding to the first photoreceptor units 20.

Further, a second distance 30B is a distance between two portions of the outer peripheral surface of the lower portion 52B on which images are formed by the two second photoreceptor units 30 or two inkjet heads when viewed in the Z direction. When the second photoreceptor drums 32 correspond to the “second image forming bodies”, two line segments connecting the second photoreceptor drums 32 and the first transfer rollers 41 respectively corresponding to the second photoreceptor drums 32 intersect with the outer peripheral surface of the lower portion 52B at two intersection portions of the outer peripheral surface. When the second photoreceptor drums 32 correspond to the “second image forming bodies”, the second distance 30B is a distance between the two intersection portions when viewed in the Z direction. When the image forming apparatus 10 is of an inkjet system, the second distance 30B is a distance between center portions of inkjet heads (second image forming bodies) corresponding to the second photoreceptor units 30.

As illustrated in FIG. 1, a developing roller 26A, a recovery auger 26B, a supply auger 26C, and a stirring auger 26D are provided inside the first developing portion 26. Similarly, a developing roller 36A, a recovery auger 36B, a supply auger 36C, and a stirring auger 36D are provided inside the second developing portion 36. The supply auger 26C and the stirring auger 26D are arranged in the X direction. In contrast, the supply auger 36C and the stirring auger 36D are arranged in the Y direction. Hence, the horizontal dimension of the second developing portion 36 is smaller than the horizontal dimension of the first developing portion 26. Thus, the horizontal dimension 30L is smaller than the horizontal dimension 20L.

As illustrated in FIG. 1, the two first photoreceptor units 20 are arranged in the X direction when viewed in the Z direction. That is, the two first photoreceptor units 20 are not arranged in the Y direction. In contrast, when viewed in the Z direction, portions of the two second photoreceptor units 30 are arranged in the Y direction. A horizontal dimension 30V illustrated in FIG. 1 is an X-direction dimension of the portions of the two second photoreceptor units 30. A horizontal dimension 30E illustrated in FIG. 1 is a horizontal dimension of a portion including the two second photoreceptor units 30. A horizontal dimension 30G illustrated in FIG. 1 is a horizontal dimension of a portion including the lower portion 52B and the two second photoreceptor units 30.

The first charging portion 24 of each first photoreceptor unit 20 charges an outer peripheral surface of the first photoreceptor drum 22. Then, the first exposure portion 25 exposes the outer peripheral surface of the first photoreceptor drum 22 charged by the first charging portion 24 to light to form an electrostatic latent image on the outer peripheral surface of the first photoreceptor drum 22. The first developing portion 26 develops the electrostatic latent image formed on the outer peripheral surface of the first photoreceptor drum 22 by the first exposure portion 25 to form a toner image. After the toner image is transferred to the transfer belt 52, the first removing portion 27 removes the toner remaining on the outer peripheral surface of the first photoreceptor drum 22.

The second charging portion 34 of each second photoreceptor unit 30 charges an outer peripheral surface of the second photoreceptor drum 32. Then, the second exposure portion 35 exposes the outer peripheral surface of the second photoreceptor drum 32 charged by the second charging portion 34 to light to form an electrostatic latent image on the outer peripheral surface of the second photoreceptor drum 32. The second developing portion 36 develops the electrostatic latent image formed on the outer peripheral surface of the second photoreceptor drum 32 by the second exposure portion 35 to form a toner image. After the toner image is transferred to the transfer belt 52, the second removing portion 37 removes the toner remaining on the outer peripheral surface of the second photoreceptor drum 32.

### Transfer Device

As illustrated in FIG. 1, the transfer device 50 includes the four first transfer rollers 41 serving as first transfer bodies, the transfer belt 52 serving as a transfer body, and a transfer cylinder 85 serving as a second transfer body. That is, the transfer device 50 first transfers the toner images formed on the outer peripheral surfaces of the respective first photoreceptor drums 22 to the transfer belt 52 in a superimposed manner, and second transfers the superimposed toner images to recording paper P.

### First Transfer Roller

As illustrated in FIG. 1, each first transfer roller 41 facing the upper portion 52A transfers the toner image formed on the outer peripheral surface of the corresponding first photoreceptor drum 22 to the outer peripheral surface of the transfer belt 52 at a first transfer position T1 between the first photoreceptor drum 22 and the first transfer roller 41. Each first transfer roller 41 facing the lower portion 52B transfers the toner image formed on the outer peripheral surface of the corresponding second photoreceptor drum 32 to the outer peripheral surface of the transfer belt 52 at a first transfer position T1 between the second photoreceptor drum 32 and the first transfer roller 41. In the present exemplary embodiment, a first transfer voltage is applied between the first transfer roller 41 and the first photoreceptor drum 22, and hence the toner image formed on the outer peripheral surface of the first photoreceptor drum 22 is transferred to the outer peripheral surface of the transfer belt 52 at the first transfer position T1. Similarly, a first transfer voltage is applied between the first transfer roller 41 and the second photoreceptor drum 32, and hence the toner image formed on the outer peripheral surface of the second photoreceptor drum 32 is transferred to the outer peripheral surface of the transfer belt 52 at the first transfer position T1.

Each first transfer roller 41 is movable in a thickness direction TD (see an arrow in FIG. 1) of the transfer belt 52. The thickness direction TD of the transfer belt 52 in this specification refers to a thickness direction of the transfer belt 52 when each of retract rollers 39, 40, 47, and 48 described later is located at a pressing position. Further, a rotation shaft of the first transfer roller 41 is urged by an urging member (not illustrated) in a direction toward an inner peripheral surface of the transfer belt 52.

### Transfer Belt

The annular transfer belt 52 illustrated in FIG. 1 is wound around the four retract rollers 39, 40, 47, and 48, the driving roller 44, a steering roller 45, a backup roller 46, and a pressing roller 49, and hence the posture is determined.

Each of the retract rollers 39, 40, 47, and 48, which are moving mechanisms of the present exemplary embodiment, is rotatably in contact with the inner peripheral surface of the transfer belt 52 and is movable in a predetermined advance-retract direction RD. Each of the retract rollers 39, 40, 47, and 48 is movable in the advance-retract direction RD between a pressing position and a retracted position that is a position on the inner peripheral side of the transfer belt 52 with respect to the pressing position. The retract roller 39 is located on the downstream side of the first photoreceptor unit 20Y and located on the upstream side of the steering roller 45. The retract roller 40 is located on the upstream side of the second photoreceptor unit 30C and located on the downstream side of the steering roller 45. The retract roller 47 is located on the downstream side of the second photoreceptor unit 30K and located on the upstream side of the backup roller 46. The retract roller 48 is located on the upstream side of the first photoreceptor unit 20Y and located on the downstream side of the driving roller 44.

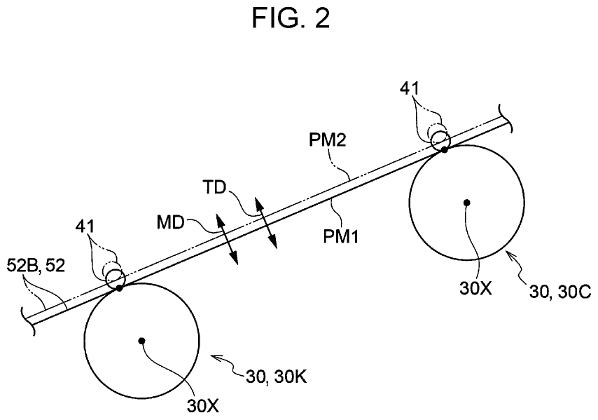

The upper portion 52A and the lower portion 52B of the transfer belt 52 are movable in a movement direction MD (see FIG. 1) extending in the thickness direction TD. As illustrated in FIG. 2, when the transfer belt 52 moves in the movement direction MD, the first transfer roller 41 moves in the thickness direction TD following the transfer belt 52.

For example, when the retract rollers 40 and 47 are located at the pressing positions, the lower portion 52B is located at a first transport position PM1 indicated by a solid line in FIG. 2. At this time, the second photoreceptor unit 30C and the second photoreceptor unit 30K may transfer the toner images to the transfer belt 52. When the retract rollers 40 and 47 are located at the retracted positions, the lower portion 52B is located at a second transport position PM2 indicated by an imaginary line in FIG. 2. At this time, the second photoreceptor unit 30C and the second photoreceptor unit 30K are not able to transfer the toner images to the transfer belt 52. Although illustration is omitted, when the retract roller 39 and the retract roller 48 are located at the pressing positions, the upper portion 52A is located at a first transport position PM1 corresponding to the first transport position PM1 in FIG. 2. At this time, the first photoreceptor unit 20Y and the first photoreceptor unit 20M may transfer the toner images to the transfer belt 52. When the retract roller 39 and the retract roller 48 are located at the retracted positions, the upper portion 52A is located at a second transport position PM2 corresponding to the second transport position PM2 in FIG. 2. At this time, the first photoreceptor unit 20Y and the first photoreceptor unit 20M are not able to transfer the toner images to the transfer belt 52. By individually controlling the positions of the respective retract rollers 39, 40, 47, and 48, only any one to three of the first and second photoreceptor units 20 and 30 may be brought into a state in which transfer to the transfer belt 52 is possible.

The movement direction MD that is a direction extending in the thickness direction TD of the transfer belt 52 includes a direction completely parallel to the thickness direction TD and a direction slightly inclined with respect to the thickness direction TD. In a case where the movement direction MD is inclined with respect to the thickness direction TD, an inclination angle defined by the movement direction MD and the thickness direction TD when viewed in the Z direction is any angle of 10° or less.

The driving roller 44 having a circular cross section is configured to be rotationally driven around an axis 44X extending in the Z direction by a driver (not illustrated), and causes the transfer belt 52 to circle at a predetermined speed in a circling direction indicated by arrow A.

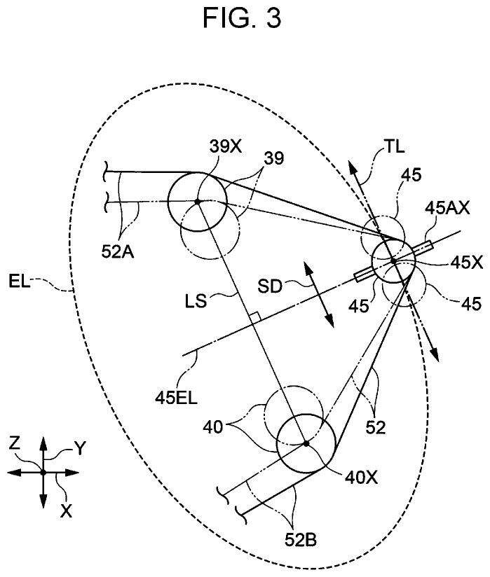

The diameter of the steering roller 45 having a circular cross section illustrated in FIGS. 1 and 3 is the same as the diameter of the driving roller 44 within a range of tolerance. In other words, an outer peripheral length 45C of the steering roller 45 and an outer peripheral length 44C of the driving roller 44 are the same within a range of tolerance. The steering roller 45 is rotatable around a rotation axis 45X extending in one direction. The steering roller 45 is an example of a change roller. Further, the steering roller 45 includes a rotation center shaft 45AX that is provided at a center portion of the steering roller 45 in a direction along the rotation axis 45X and that intersects with the rotation axis 45X. The rotation center shaft 45AX is rotatably supported by a rotation support portion (not illustrated) included in the image forming apparatus 10. Thus, the steering roller 45 is rotatable around the rotation center shaft 45AX. The position of the steering roller 45 in a rotation direction SD around the rotation center shaft 45AX when the rotation axis 45X is parallel to the Z direction is a neutral position of the steering roller 45. Further, the transfer device 50 includes a driving mechanism (not illustrated) that rotates the steering roller 45 around the rotation center shaft 45AX by applying a driving force to the steering roller 45. When the transfer belt 52 moves (meanders) in the width direction, if a movement amount detection device (not illustrated) detects a movement amount (meandering amount) of the transfer belt 52 in the width direction, the driving mechanism applies a driving force corresponding to the detected movement amount to the steering roller 45. Accordingly, the angle of the rotation axis 45X of the steering roller 45 rotated around the rotation center shaft 45AX with respect to the width direction (Z direction) of the transfer belt 52 changes. Consequently, meandering of the transfer belt 52 is suppressed by the steering roller 45.

In this case, as illustrated in FIG. 3, an ellipse EL (see a dotted-chain line in FIG. 3) is assumed in which rotation axes 39X and 40X of the retract rollers 39 and 40 located at the pressing positions (the positions indicated by solid lines) serve as two foci. When the transfer device 50 is viewed along the rotation axes 39X and 40X of the retract rollers 39 and 40, the rotation direction SD of the steering roller 45 is along a tangent line TL (see an imaginary line in FIG. 3) that is in contact with the ellipse EL at a position passing through the rotation axis 45X of the steering roller 45 at the neutral position. When the retract rollers 39 and 40 are located at either the pressing positions or the retracted positions, the rotation direction SD is along the direction of the tangent line TL. Further, when the retract rollers 39 and 40 are located at the pressing positions, the angle formed by the rotation direction SD and the tangent line TL is minimized. In other words, the angle formed by the rotation direction SD and the tangent line TL when the retract rollers 39 and 40 are located at the pressing positions is smaller than the angle formed by the rotation direction SD and the tangent line TL when at least one of the retract rollers 39 and 40 is located at the retracted position. Further, when the transfer device 50 is viewed along the rotation axes 39X and 40X of the retract rollers 39 and 40, an extension line 45EL of the rotation center shaft 45AX passes through the midpoint of a line segment LS connecting the retract roller 39 located at the pressing position and the retract roller 40 located at the pressing position, and the line segment LS is orthogonal to the extension line 45EL.

In this case, “the rotation direction SD is along the direction of the tangent line TL” includes that the rotation direction SD and the direction of the tangent line TL are completely parallel to each other and that the rotation direction SD is slightly inclined with respect to the direction of the tangent line TL. An inclination angle formed by the rotation direction SD and the tangent line TL when viewed in the Z direction in a case where the rotation direction SD is inclined with respect to the direction of the tangent line TL is any angle of 10° or less.

In the exemplary embodiment, the positions of the rotation axes 39X and 40X are set so that the retract rollers 39 and 40 are symmetrical about the extension line 45EL. However, as long as the inclination angle formed by the rotation direction SD and the tangent line TL becomes any angle of 10° or less, one of the retract roller 39 and the retract roller 40 may be provided at a position slightly shifted from these positions.

The first distance 20B of the two first photoreceptor drums 22 and the second distance 30B of the two second photoreceptor drums 32 are set to be integral multiples of the outer peripheral length 44C of the driving roller 44 and the outer peripheral length 45C of the steering roller 45. The second distance 30B is smaller than the first distance 20B. For example, the first distance 20B of the present exemplary embodiment is set to be four times the outer peripheral length 44C and the outer peripheral length 45C, and the second distance 30B is set to be three times the outer peripheral length 44C and the outer peripheral length 45C.

A distance along the transfer belt 52 between the first transfer position T1 of the first photoreceptor drum 22 on the downstream side and the first transfer position T1 of the second photoreceptor drum 32 on the upstream side is different from the first distance 20B and the second distance 30B. That is, the distance along the transfer belt 52 between the first transfer position T1 of the first photoreceptor drum 22 on the downstream side and the first transfer position T1 of the second photoreceptor drum 32 on the upstream side does not correspond to an “adjacent distance (first distance, second distance)” in the claims. The distance along the transfer belt 52 between the first transfer position T1 of the first photoreceptor drum 22 on the downstream side and the first transfer position T1 of the second photoreceptor drum 32 on the upstream side is also set to an integral multiple of the outer peripheral length 44C of the driving roller 44 and the outer peripheral length 45C of the steering roller 45.

The backup roller 46 faces the transfer cylinder 85 with the transfer belt 52 interposed therebetween. A region where the transfer cylinder 85 and the transfer belt 52 are in contact with each other is the nip region Np (see FIG. 1). The nip region Np is the second transfer position T2 where the toner images are transferred from the transfer belt 52 to the recording paper P.

Further, the pressing roller 49 located on the upstream side of the retract roller 48 and on the downstream side of the driving roller 44 is rotatably in contact with the outer peripheral surface of the transfer belt 52 and presses the transfer belt 52 toward the inner peripheral side.

### Transport Section

As illustrated in FIG. 1, the transport section 16 includes a transport device (not illustrated) that transports recording paper P sent out from the storage section 14 in a direction of arrow B. The recording paper P sent out from the storage section 14 is transported to the transfer cylinder 85 by the transport device. The recording paper P on which a toner image has been second transferred by passing through the transfer cylinder 85 (second transfer position T2) is transported to the fixing device 18 by the transport device.

### Fixing Device

As illustrated in FIG. 1, the fixing device 18 includes a heating roller 42 as an example of a heating member and a pressure roller 43 as an example of a pressure member. The fixing device 18 fixes the toner image transferred on the recording paper P by the transfer cylinder 85 to the recording paper P by sandwiching the recording paper P between the heating roller 42 and the pressure roller 43 and heating and pressing the recording paper P.

Next, operations and effects of the image forming apparatus 10 configured as described above will be described in detail.

In the image forming apparatus 10 of the exemplary embodiment, the second distance 30B between the two second photoreceptor drums 32 located on the downstream side of the first photoreceptor drums 22 is smaller than the first distance 20B. In a comparative example (not illustrated) in which the second distance 30B is set to be larger than or equal to the first distance 20B, the second distance 30B is set to meet the first distance 20B. Thus, the distance along the transfer belt 52 from the driving roller 44 to the second photoreceptor unit 30K is smaller in this exemplary embodiment than that in the comparative example. As the distance increases, the cumulative amounts of the speed fluctuation of the transfer belt 52 and the error of the adjacent distance increase. Thus, in the comparative example, the displacement amount of the registration of the toner images between the second photoreceptor unit 30C and the second photoreceptor unit 30K is likely to be larger than the displacement amount of the registration of the toner images between the first photoreceptor unit 20Y and the first photoreceptor unit 20M. In contrast, in the exemplary embodiment, since the distance (second distance 30B) between the second photoreceptor unit 30C and the second photoreceptor unit 30K is smaller than that in the comparative example, the cumulative amounts of the speed fluctuation and the error of the adjacent distance are smaller than those in the comparative example. Thus, in the present exemplary embodiment, as compared with a case where the second distance 30B is set to be a length larger than or equal to the first distance 20B, a situation in which the displacement amount of the registration of the toner images increases as the position of the photoreceptor drum is located on the more downstream side of the transfer belt 52 is suppressed.

Further, in the image forming apparatus 10 of the exemplary embodiment, when the transfer device 50 is viewed along the rotation axes 39X and 40X of the retract rollers 39 and 40, the rotation direction SD of the steering roller 45 at the neutral position is along the tangent line TL of the ellipse EL at the position passing through the steering roller 45. Hence, as compared with a case where the rotation direction SD of the steering roller 45 at the neutral position is different from the direction of the tangent line TL, a difference in peripheral length between both side edge portions of the transfer belt 52 when the steering roller 45 rotates is small. Thus, as compared with a case where the rotation direction SD of the steering roller 45 located at the neutral position is different from the direction of the tangent line TL, an increase in the displacement amount of the registration of the toner images formed on the transfer belt (formation target body) 52 by the two second photoreceptor drums 32 located on the downstream side of the steering roller 45 is suppressed.

Further, when viewed in the Z direction, the acute angle θB defined by the lower portion 52B being straight-line shaped and the horizontal direction (X direction) is larger than the angle RA defined by the upper portion 52A being straight-line shaped and the horizontal direction. The two second photoreceptor units 30 are provided along the lower portion 52B. Further, the second distance 30B that is the distance (adjacent distance) between the two rotation axes 30X when viewed in the Z direction is smaller than the first distance 20B that is the distance (adjacent distance) between the two rotation axes 20X. Hence, as compared with a case where the intervals between multiple adjacent image forming bodies (the first photoreceptor drums 22 and the second photoreceptor drums 32) disposed at each of the upper portion 52A and the lower portion 52B are all the same, the horizontal dimension 30G of the portion including the lower portion 52B and the two second photoreceptor units 30 is small. Further, a horizontal distance 30BH (see FIG. 1) that is a distance in the horizontal direction between two portions on the transfer belt 52 on which images are formed by the second photoreceptor units 30 is smaller than the first distance 20B when viewed in the Z direction. Accordingly, the image forming apparatus 10 has a smaller horizontal dimension when viewed in the Z direction than a case where multiple adjacent image forming bodies are arranged at each of the upper portion 52A and the lower portion 52B at the same interval.

The second distance (adjacent distance) 30B, which is the distance between the rotation axes 30X of the two second photoreceptor drums 32 located on the downstream side of the steering roller 45 and on the upstream side of the transfer position to recording paper P, is an integral multiple of the outer peripheral length 45C of the steering roller 45. Thus, as compared with a case where the second distance 30B is different from an integral multiple of the outer peripheral length 45C, an increase in the displacement amount of the registration of the toner images formed on the transfer belt (formation target body) 52 by the two second photoreceptor drums 32 located on the downstream side of the steering roller 45 is suppressed.

Further, in the image forming apparatus 10, the first distance 20B between the two first photoreceptor drums 22 and the second distance 30B between the two second photoreceptor drums 32 each are set to be an integral multiple of the outer peripheral length 44C of the driving roller 44. Thus, as compared with a case where the first distance 20B and the second distance 30B are set to lengths different from integral multiples of the outer peripheral length 44C, an increase in the displacement amount of the registration of the toner images formed on the transfer belt (formation target body) 52 by the two second photoreceptor drums 32 located on the downstream side of the steering roller 45 is suppressed.

The image forming apparatus 10 according to the exemplary embodiment has been described above based on the drawings. However, the image forming apparatus 10 according to the exemplary embodiment is not limited to that illustrated in the drawings, and may be appropriately changed in design without departing from the scope of the present disclosure.

For example, the image forming apparatus 10 may be configured such that each of the first photoreceptor units 20 and each of the second photoreceptor units 30 form toner images on recording paper P (formation target body) transported by a transport belt (not illustrated) provided instead of the transfer belt 52.

In the present exemplary embodiment, a toner image is described as an example of an image. In this case, the toner image is formed by a dry electrophotographic system, but the present disclosure is not limited to this. For example, an image of the present disclosure may be a toner image formed by a wet electrophotographic system or an image formed by an inkjet system.

Further, the image forming apparatus 10 may be configured such that an ink image or a toner image is formed on an elongated non-annular continuous paper (formation target body) that is wound around multiple rotating bodies including the driving roller 44 and that is transported by the driving roller 44 and the rotating bodies while having a shape having at least one straight portion when viewed in the Z direction, and such that the steering roller (change roller) 45 is rotatably in contact with the inner peripheral surface of the continuous paper.

In a case where the image forming apparatus 10 includes the first photoreceptor units 20 and the second photoreceptor units 30, the adjacent distances may be the same within a range of tolerance. Similarly, in a case where the image forming apparatus 10 includes inkjet heads, respective adjacent distances may be the same within a range of tolerance.

In a case where the image forming apparatus 10 includes any ones of the first photoreceptor units 20, the second photoreceptor units 30, and the inkjet heads, the respective adjacent distances may not be integral multiples of the outer peripheral length 44C or the outer peripheral length 45C.

The diameter of the steering roller 45 and the diameter of the driving roller 44 may be different from each other. However, also in this case, the diameters of the steering roller 45 and the driving roller 44 may be set so that the respective adjacent distances are integral multiples of the outer peripheral length 45C and the outer peripheral length 44C.

The number of colors of images (toner images or ink images) formed on a formation target body (transfer belt 52 or recording paper P) need not be four. For example, the number of colors of images may be six.

For example, three or more image forming bodies may be arranged along the upper portion 52A. Similarly, three or more image forming bodies may be arranged along the lower portion 52B.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an annular formation target body to be transported;
a change roller that is in contact with an inner peripheral surface of the formation target body so as to be rotatable around a rotation axis and that is capable of changing an angle of the rotation axis with respect to a width direction of the formation target body;
a plurality of first image forming bodies that are arranged at a first distance from each other along the formation target body on an upstream side of the change roller in a transport direction of the formation target body, and that form images on the formation target body; and
a plurality of second image forming bodies that are arranged at a second distance smaller than the first distance from each other along the formation target body on a downstream side of the change roller in the transport direction of the formation target body, and that form images on the formation target body.

2. The image forming apparatus according to claim 1, comprising:
a first roller that is located between the first image forming body located on a most downstream side among the plurality of first image forming bodies and the change roller and that is rotatably in contact with the inner peripheral surface of the formation target body; and
a second roller that is located between the second image forming body located on a most upstream side among the plurality of second image forming bodies and the change roller and that is rotatably in contact with the inner peripheral surface of the formation target body,
wherein the change roller changes an angle of the rotation axis with respect to the width direction of the formation target body by rotating around a rotation center shaft intersecting with the rotation axis, and
wherein, when viewed along a rotation axis of the first roller and a rotation axis of the second roller, a rotation direction around the rotation center shaft of the change roller extends in a direction of a tangent line of an ellipse having the rotation axis of the first roller and the rotation axis of the second roller as foci.

3. The image forming apparatus according to claim 1,
wherein the formation target body includes a first straight portion that is straight-line shaped when viewed along the rotation axis and is located on the upstream side of the change roller, and a second straight portion that is straight-line shaped when viewed along the rotation axis and is located on the downstream side of the change roller, and
wherein an angle that is an acute angle defined between the second straight portion and a horizontal direction is larger than an angle that is an acute angle defined between the first straight portion and the horizontal direction or an angle of 0°.

4. The image forming apparatus according to claim 2,
wherein the formation target body includes a first straight portion that is straight-line shaped when viewed along the rotation axis and is located on the upstream side of the change roller, and a second straight portion that is straight-line shaped when viewed along the rotation axis and is located on the downstream side of the change roller, and
wherein an angle that is an acute angle defined between the second straight portion and a horizontal direction is larger than an angle that is an acute angle defined between the first straight portion and the horizontal direction or an angle of 0°.

5. The image forming apparatus according to claim 1, comprising a driving roller that is rotatably in contact with the inner peripheral surface of the formation target body on the upstream side of the change roller.

6. The image forming apparatus according to claim 2, comprising a driving roller that is rotatably in contact with the inner peripheral surface of the formation target body on the upstream side of the change roller.

7. The image forming apparatus according to claim 3, comprising a driving roller that is rotatably in contact with the inner peripheral surface of the formation target body on the upstream side of the change roller.

8. The image forming apparatus according to claim 4, comprising a driving roller that is rotatably in contact with the inner peripheral surface of the formation target body on the upstream side of the change roller.

9. The image forming apparatus according to claim 1, wherein the second distance is an integral multiple of an outer peripheral length of the change roller.

10. The image forming apparatus according to claim 2, wherein the second distance is an integral multiple of an outer peripheral length of the change roller.

11. The image forming apparatus according to claim 3, wherein the second distance is an integral multiple of an outer peripheral length of the change roller.

12. The image forming apparatus according to claim 4, wherein the second distance is an integral multiple of an outer peripheral length of the change roller.

13. The image forming apparatus according to claim 5, wherein the second distance is an integral multiple of an outer peripheral length of the change roller.

14. The image forming apparatus according to claim 6, wherein the second distance is an integral multiple of an outer peripheral length of the change roller.

15. The image forming apparatus according to claim 7, wherein the second distance is an integral multiple of an outer peripheral length of the change roller.

16. The image forming apparatus according to claim 8, wherein the second distance is an integral multiple of an outer peripheral length of the change roller.
